(19) United States
(12) Patent Application Publication
(10) Pub. No.: US 2008/0151050 A1
(43) Pub. Date: Jun. 26, 2008

(54) Enhanced Multimedia Intrusion Notification System and Method

(76) Inventor: Michael R. Self, Fort Lauderdale, FL (US)

Correspondence Address: ROBERT M. SCHWARTZ, P.A., P.O. BOX 221470, HOLLYWOOD, FL, 33022, US

(21) Appl. No.: 11/959,039

(22) Filed: Dec. 18, 2007

Related U.S. Application Data
(60) Provisional application No. 60/871,060, filed on Dec. 20, 2006.
(60) Provisional application No. 60/894,729, filed on Mar. 14, 2007.

(51) Int. Cl. H04N 7/18

(52) U.S. Cl. 348/143; 348/E07.085

(57) ABSTRACT

A system and method are provided for remotely providing multimedia information to a user, which allows the user to evaluate whether an intrusion has occurred. More particularly, image and/or other information is captured in response to the detection of motion in a monitored area. Additionally, at least one of image information and audio information is, ultimately, formatted for viewing and/or listening on a particular mobile device of the user, based on the particular characteristics of that device, and provided to the user, in that format.

### CROSS-REFERENCE TO RELATED APPLICATION

The present application claims priority from co-pending provisional patent application Ser. No. 60/871,060, filed Dec. 20, 2006, and entitled METHOD AND PROCESS FOR ENHANCED VIDEO NOTIFICATION OF INTRUSION, and from co-pending provisional patent application Ser. No. 60/894,729, filed on Mar. 14, 2007, and entitled METHOD AND PROCESS FOR ENHANCED MULTIMEDIA NOTIFICATION OF INTRUSION, those applications being incorporated herein, by reference, in their entirety.

### BACKGROUND OF THE INVENTION

1. Field of the Invention

The invention relates to a system and method for enhanced multimedia notification of an intrusion of the type typically monitored by a burglar alarm system, and more particularly to a multimedia notification system and method that provides a remote location with multimedia information upon detection of an intrusion.

2. Description of the Related Art

Systems are known that use “nanny-cams” or surveillance cameras to stream video continuously to the Internet. In such systems, video cameras are continuously operating and can be accessed remotely by a user to watch the real-time streaming video. However, such systems do not inform a user of an intrusion, or provide image information of that intrusion to the user. Rather, a user would need to be monitoring the system at all times, in order to detect an intrusion. Additionally, the camera of these systems must be continuously operating and transmitting video, which utilizes a great deal of electricity during the day.

U.S. Pat. No. 7,034,681 to Yamamoto et al., entitled “Home Security Video System Using Internet Technique” describes a security system including several camera devices and a communication device in sites at which monitoring is required by a user. In the system of Yamamoto et al., several camera devices constantly monitor the sites. The camera devices of Yamamoto et al., have motion detecting functions and provide unusual status reporting signals and necessary image information to the communications device when the movements of an intruder have been detected. More particularly, Yamamoto et al., discloses that when an image of a moving intruder is imaged in camera image-receiving component, the presence of the intruder can be detected from the information relating to movement in the image data in data-processing component which has received the corresponding image data. The communication device of Yamamoto et al., communicates with and is connected to a server that serves as an information center via the internet line when unusual status signals have been received. In Yamamoto et al., the information from the camera devices is also sent to server. The server of Yamamoto et al., automatically notifies the user by a predetermined user-selected method, after which, the notified user can confirm the information by accessing the web site later. Col. 5 of Yamamoto et al., lines 60-62, disclose that the means of notification can be an electronic mail using internet line 80 to deliver mail to user terminal 28, portable telephone through the telephone company 65 or a telephone 66 in a fixed position. (See FIG. 1.)

As such, since motion is detected using the image data in Yamamoto et al, the cameras of Yamamoto et al., like those described above, must run continuously. Further, Yamamoto et al., discloses providing notification to a portable telephone, through the telephone company, but does not disclose transmitting images to, or viewing images on, the user's portable phone.

Additionally, there have been described various so-called “cell phone security-camera products”, wherein a user can monitor their properties on the screen of a cell phone. One such system called “MOBILARM” by SECURECOM TECHNOLOGIES of Southfield, Mich., transmitted a picture only when a customer dialed into the system, so as not to tie up the cellular network. Additionally, the MOBILARM system was described as being connectable to an existing security system, so that, if an alarm was tripped, MOBILARM would send a test message to the client's phone, without interfering with the alarm system's automatic call to the police or a security company. As with the above-described “nanny-cams”, the cameras of such systems run continuously, thus using a great deal of electricity. Additionally, in the above-described MOBILARM system, only a text message is sent to the customer as a result of an alarm, but not any video. Rather, in the MOBILARM system, the customer must still initiate the connection to the system to view the currently available, streamed video from the cameras.

Further, mobile devices, such as the cell phone and mobile phone, use a technology (i.e., Multimedia Messaging Service (MMS)), providing a standard for telephony messaging systems, that allow sending messages that includes multimedia data (e.g., images, audio, video, and Rich Text) and not just text messages. MMS enabled mobile devices include content types that should conform to the MMS standards, for example, MPEG-4 video and AVI format. Generally, mobile cell phones follow the standards defined by the OMA. However, although the file compression format may be standardized by MMS, each of the mobile devices available in the marketplace has different image viewing format characteristics (e.g., screen size, frames per second, and how the video should be delivered to the cell phone/handset). As such, a standard MPEG-4 or AVI sent to mobile devices of different types may still display differently on each device, depending on the image viewing format characteristics of the particular device.

U.S. Patent Application Publication No. 2007/0063840 to Jentoft, entitled “Security Monitoring Arrangement and Method Using a Common Field of View”, discloses the use of a passive infrared sensor, which detects changes in infrared energy to detect motion and, when the sensor is “armed”, to activate a camera to record images of a source of detected motion. However, Jentoft discloses that the recorded video is sent to an outside monitoring facility, such as a private security company or a local law enforcement station.

What is needed is an intrusion detection system that provides a user with useful multimedia information, wherein the camera(s) need not run continuously. What is additionally needed is an intrusion detection system wherein at least image and/or audio data from the captured multimedia information can be provided to a mobile user device, regardless of device type.

### SUMMARY OF THE INVENTION

It is accordingly an object of the invention to provide a system and method for remotely providing multimedia information to a user that allows the user to evaluate whether an intrusion has occurred. In one particular embodiment of the present invention, image and/or audio information is captured in response to the detection of motion in a monitored area, which image and/or audio information is, ultimately, formatted for viewing and/or listening on a mobile device of the user and is provided to the user in that format.

Other features which are considered as characteristic for the invention are set forth in the appended claims.

Although the invention is illustrated and described herein as embodied in an Enhanced Multimedia Intrusion Notification System And Method, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE DRAWINGS

The present invention is illustrated by way of example, and not by way of limitation, in the figures of the accompanying drawings, in which like reference numerals refer to similar elements and in which:

FIG. 1 is a simplified diagram of a system in accordance with one particular embodiment of the instant invention;

FIG. 2 is a front view of a motion-detecting camera for use with one particular embodiment of the instant invention;

FIG. 3 is a flow diagram of a method of operation of an intrusion detection system, in accordance with one particular embodiment of the present invention;

FIG. 4 is a partial perspective view of a mobile device downloading the reformatted image data, in accordance with one particular embodiment of the present invention;

FIG. 5 is a partial perspective view of a mobile device showing on the screen, thereof, a captured frame from the image data downloaded in FIG. 4; and

FIG. 6 is a front elevational view of a mobile device including downloaded captured image data displayed on its screen, in accordance with one particular embodiment of the present invention.

### DESCRIPTION OF THE PREFERRED EMBODIMENTS

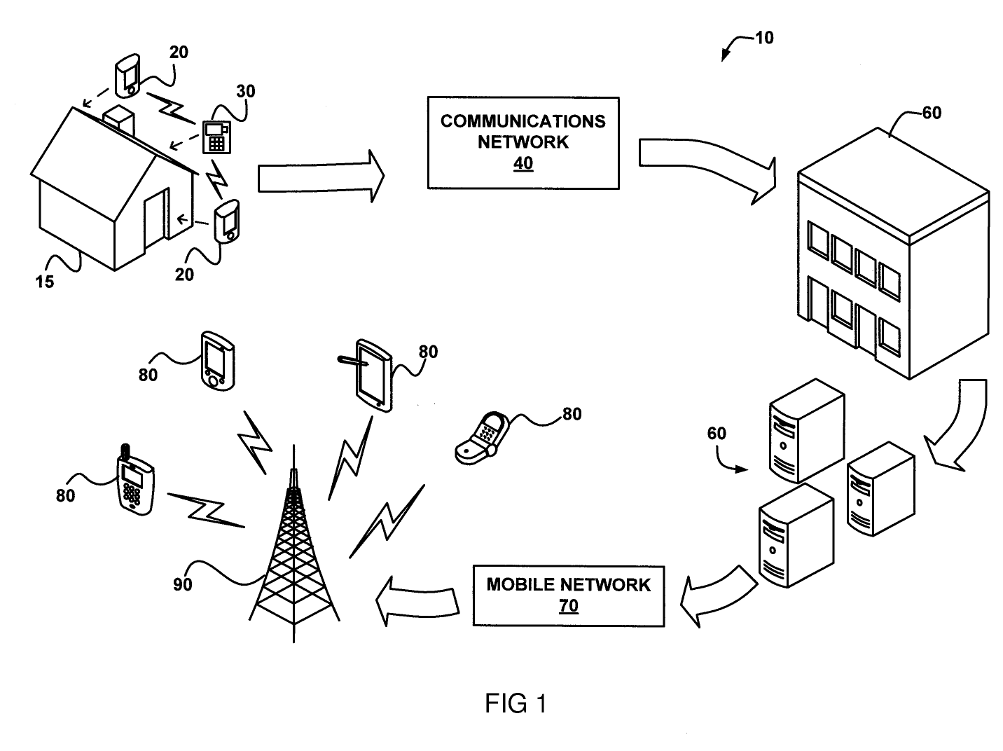

Referring now to FIG. 1, there is shown a simplified diagram of a system 10 for remotely providing multimedia information to a user that allows the user to evaluate whether an intrusion has occurred. As used herein “multimedia” can include image, audio and/or video content, among other types of content.

In FIG. 1, there is shown a home 15 that is protected by, as will be shown in the present example, a wireless low powered alarm system that is capable of detecting motion. Note that although a home is shown, this is not meant to be limiting, as other locations can be monitored with the present system, including, a store, business, warehouse, construction site, apartment complex, garage, etc. Additionally, if desired, the present intrusion monitoring system can be used with “items” as well. For example, such system can send multimedia information to a user reporting information on, for example, a person who opened a particular briefcase, suitcase, vehicle, etc. However, for explanatory purposes, a house 15 is described herein.

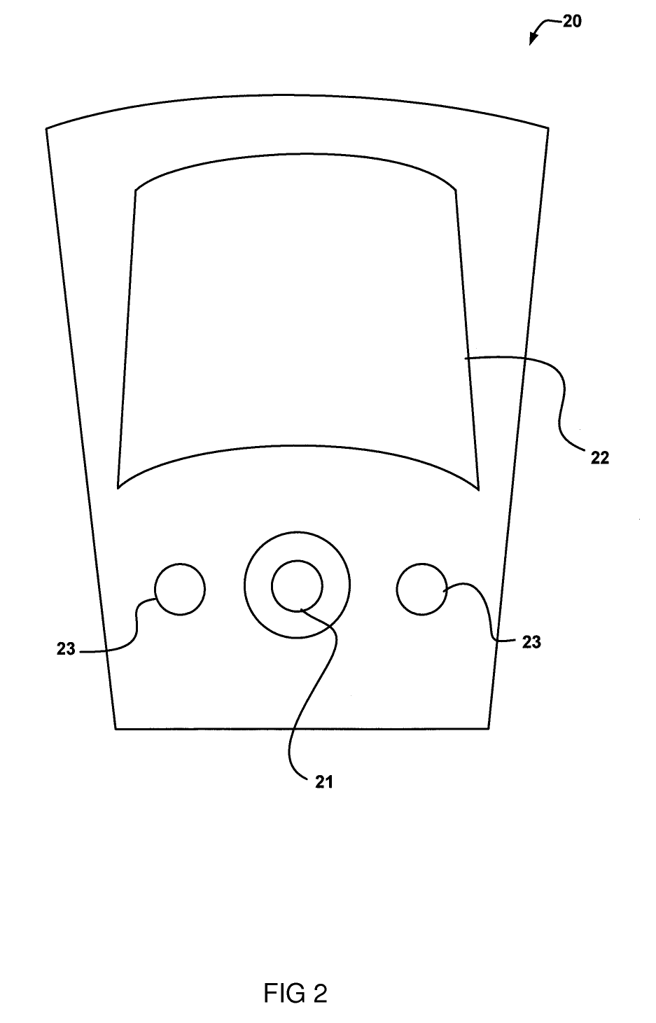

Referring to FIGS. 1 and 2, the house 15 is shown. House 15 includes one or more motion-detecting camera assemblies 20, therein (as represented by the dotted lines), each of which includes a motion-detecting portion (22 of FIG. 2) and a camera (21 of FIG. 2). The motion detecting camera assemblies 20 can additionally include circuitry for capturing other types of information, including audio information, in response to the detection of motion, if desired. Further, if desired, the motion detecting camera assemblies 20 can additionally include one or more infrared LEDs (23 of FIG. 2), for providing night illumination. In such an embodiment, the motion-detecting portion 22 can include a passive IR sensor that detects IR light reflected from the infrared LEDs 23. Examples of particular motion-detecting camera assemblies and systems that can be used in connection with the present invention are disclosed in U.S. Patent Application Publication No. 2007/00634840 to Jentoft, and U.S. Patent Application Publication Nos. 2007/0066311 and 2007/0257195, both to Reibel et al., those three patent application publications being incorporated herein, by reference, in their entireties. One particular commercial example of a type of motion-detecting camera assembly that can be used with the present invention, is the P-CAM wireless motion detector manufactured by RSI Alarm from Strasbourg, France. However, the invention is not intended to be limited only to the above-cited types of motion detection, as other types of motion detection may be used and still be within the scope of the instant invention.

Referring back to FIGS. 1 and 2, the camera 21 of each motion-detecting camera assembly 20 is designed to capture image information when triggered by the detection of motion within the viewing area or range of the motion detection portion 22. For example, upon detection of any type of movement by the sensor 22, the camera 21 can be triggered to automatically record a limited amount of image data. In one particular embodiment, the camera 21 may capture one or more still images. In another particular embodiment, the camera 21 will capture image data in the form of a video clip, for a limited period of time. For example, in one particular embodiment, the camera records about ten (10) seconds worth of video of whatever is in the camera's “view”, so as to include the intrusion that triggered the motion. Similarly, if audio/sound recording circuitry is included within the motion detecting camera assemblies 20, that circuitry would be actuated by the detection of motion by the sensor 22, in order to capture a limited amount of audio information (for example, ten seconds of audio) coincident with the detected motion.

Because of the selective activation of the camera 21 (i.e., only upon the detection of motion), the motion-detecting camera assemblies 20 do not use a great deal of energy. As such, in one particular embodiment of the invention, the motion-detecting camera assemblies 20 are powered by batteries, thus avoiding the requirement for an AC power connection and enhancing the portability of the assemblies 20.

Additionally, the motion-detecting camera assemblies 20 include communication circuitry for communicating an indication of the detection of motion and the captured image and/or audio data to outside of the assemblies 20. More particularly, in one preferred embodiment, image data captured by the camera 21 is sent to a control unit or panel 30, additionally located on the premises of house 15. This panel 30 may be either portable or fixed to the premises, and may be connected to the motion-detecting camera assemblies 20 and/or other sensors by wires or by wireless connections as known in the art. In one particular embodiment of the present invention, the image data is transmitted wirelessly, using a low power RF (Radio Frequency) connection from the motion-detecting camera assembly 20 to the panel 30. Similarly, captured audio information can be sent to the panel 30 with the image data. Additionally, the panel 30 may be used to selectively arm the motion-detecting camera assemblies 20 and to relay information from those assemblies 20 to a remote location 50. If desired, the panel 30 may be omitted, and the assemblies 20 can include circuitry (such as telephone circuitry) that permits them to transmit alarm information directly to a remote location 50.

The panel 30 (or assembly 20) sends the image and/or audio information from the camera 21 to a remote central station, via a communications network 40. In one preferred embodiment, the camera 21 processes the image and/or audio data prior to transmission. For example, an image processor in the camera 21 formats the captured image data in a defined file format, such as MPEG or MPEG2 for video, and/or JPEG for still images. Similarly, captured audio information can be processed and compressed/formatted (i.e., AVI, MP3, etc.) by circuitry within the motion detecting camera assembly 20, prior to transmission to the panel 30. Alternately, raw image and/or audio data can be sent to the control panel 30 and/or the remote location 50 for processing in those locations. In one particular preferred embodiment of the present invention, the camera 21 captures a ten (10) second long video clip and/or ten seconds of audio information, and formats it as a file in accordance with the MPEG compression standard, which file is then transmitted to the panel 30. In the presently described particular embodiment, the panel 30 then sends the MPEG file to the remote location 50, via the communications network 40.

Preferably, the communications network 40 is a publicly available network, such as a public switched telephone network, a cellular or other mobile network, a publicly available satellite network and combinations thereof. Note, however, that a private communications link between each home 15 and the remote location 50 could additionally be used, if desired.

In the system of the present invention, the remote location 50 is a monitoring center affiliated with a service provider, which monitoring center monitors a plurality of locations, such as a plurality of homes 15. Note that, although one monitoring center is shown, more than one monitoring center 50 can be part of the system 10, for example, supporting different geographic zones and/or regions. In the system 10 of the instant invention, the alarm indication and image data from the home 15 is routed to the appropriate monitoring center affiliated with the service provider for the alarm system in the home 15.

The image and/or audio data is received at the monitoring center 50 wherein it can be viewed/heard by the monitoring center personnel, in order to make a decision whether to dispatch local law enforcement or other security personnel. However, in accordance with the instant invention, the image and/or audio data received at the monitoring center 50 is further processed/reformatted on computers and/or servers 60 affiliated with the service provider for transmission through a mobile network 70.

More particularly, the present invention converts the multimedia data, including the image data captured by the camera 21 and/or any audio data, into a format that is useful to the user or end-user of the present system, in dependence upon the particular format characteristics defined by the particular type and model of mobile device 80 associated with the user. For purposes of the present application, a “user” or “end-user”, as defined herein, is either the actual owner of the home 15 (or other location), or a pre-designated recipient of communications from the service provider about the intrusion status of the home 15 or other location. As such, the “user” or “end-user” is intended to be the consumer who contracted with the service provider, or a representative of the consumer, and not an employee of the service provider. Further, in the present invention, the user or end-user has agreed to receive communications from the service provider on one or more of a mobile device 80 associated with the user, and pre-informed the service provider of the type and/or model of the designated mobile device 80. As such, for purposes of the present invention, at least one particular mobile device 80 is, in actuality, associated with each particular monitored location, such as the home 15.

Computer(s) and/or server(s) 60 affiliated with the service provider include databases of users to be contacted upon an alarm condition occurring at locations supervised by the service provider, with at least one user associated with each supervised location. In the preferred embodiment, the database relating to the user includes identification information that identifies the one (1) or more mobile device(s) 80 (i.e., the particular make and model of mobile telephone, smartphone, PDA, etc.), worldwide, associated with the user, so the service provider knows where to send or forward information about the detected intrusion, including image data received from the camera 21.

The identification information included in the database includes information that identifies the type and model of mobile device 80, designated to receive information about alarm conditions at a particular location. Such identification information can be information previously accumulated from the user. The database will additionally include information and/or look-up tables relating each available type and model of mobile device with certain image and/or audio data format characteristics (e.g., screen size, frames per second, and how the images and/or audio should be delivered to the device/cell phone/handset). Because each type and model of mobile device 80 has different format characteristics, the system of the present invention utilizes computers 60 to reformat the received image and/or audio data, according to the format characteristics of the particular type and model of mobile device 80 designated to receive the image and/or audio data.

The reformatted image and/or audio data is provided to a particularly targeted one of the mobile devices 80, via the mobile network 70, usually via a local cell tower 90. Note that a variety of different mobile devices 80 that can receive image and audio data (i.e., smartphones, mobile phones, PDAs, Tablet PCs, etc.) via the mobile network 70 are currently available on the market. As will be discussed further, below, the reformatted multimedia data can be provided to a user automatically or in response to a request from that user for the data.

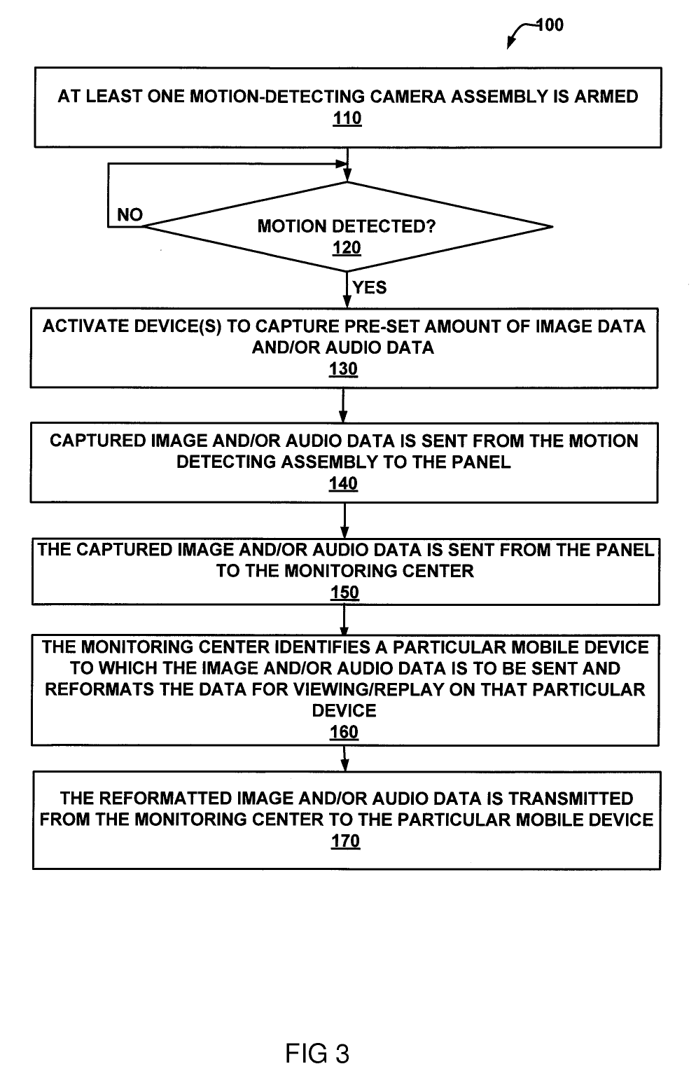

Referring now to FIGS. 1-3, there will be described a method of operation 100 of an intrusion detection system, in accordance with one particular embodiment of the present invention.

First, the alarm system including at least one motion-detecting camera assembly is armed. Step 110. This can be done at the panel 30, or, if no panel 30 is used, at each of the assemblies 20. Each motion-detecting camera assembly 20 remains passive (step 120) until the motion-detecting portion 22 detects motion. Upon detection of motion at one of the motion detecting sensors 22, the camera 21 associated with that sensor 22 is activated to capture a pre-set amount of image data. Step 130. For example, is discussed above, in one particularly preferred embodiment, the camera 21 is pre-set to record video for a predetermined amount of time (i.e., at least ten (10) seconds). In another embodiment, the camera can capture other amounts of video or can capture a predetermined (pre-programmed) number of still images (i.e., more or less image data can be captured and/or sent). Additionally, or alternatively, as noted above, the motion-detecting assembly 20 can capture a limited amount of audio information in response to the detection of motion, if desired.

In the method of the present embodiment, wherein panel 30 is provided, the captured image data and/or audio data is transmitted to panel 30 on the premises. Step 140. However, if the communication circuitry in the motion-detecting camera assembly 20 includes sufficient circuitry to communicate directly with the central station 50, via the communication network 40, step 140, as well as panel 30, may be omitted. In one particularly preferred embodiment of the invention, the panel 30 is hidden on the premises of home 15 and the assemblies 20 send the captured image data and/or audio data to the panel 30, via wireless communication circuitry located in the assembly 20 and the panel 30.

Previously, at the time of installation of the panel 30 on the premises 15, the panel 30 is provided with the equipment and information necessary to communicate the received image data to the central station 50, via a communications network 40. For example, the panel 30 can include wireless communication circuitry that initiates a call over a mobile network using GSM or GPRS protocols. Alternately, the panel 30 can be connected to a landline on the premises that is connected to the public switched telephone network. As another alternative, the panel can be connected to the monitoring center via a WAN, LAN and/or Internet connection. Additionally, further communications networks, and/or combinations thereof, can be used as the communications network 40.

Upon receiving an alarm and image data from an assembly 20, the panel communicates the alarm and image information to the monitoring center 50, using a modem or other conversion device. Step 150. Panel 30 includes software, known in the art, that will take the image data from camera 21 and, if available, audio data from audio capture circuitry in the assemblies 20, and transmit it to the monitoring center. As discussed above, preferably the camera 21 processes the image data and/or audio data and prepares it into a standardized format, such as in accordance with the MPEG, AVI and/or JPEG compression standards, prior to sending it to the panel 30. However, if desired, the raw image and/or audio data can be provided to the panel 30, and the panel 30 can process it in accordance with some form of image standard. Additionally, if desired, the raw image data and/or audio data (i.e., multimedia data) could be provided to the monitoring center 50, or the image and/or audio data could be provided in an encoded or encrypted format. The panel 30 additionally provides with the alarm and multimedia data information identifying the particular location from which the alarm and image and/or audio or other multimedia data are being transmitted.

Once the alarm and multimedia information is received at the monitoring center, the computers/servers affiliated with the monitoring center decode and/or decrypt the received information and search it for identification information that identifies from where the alarm and multimedia information came. The computers/servers 60 use the identification information to find in the database the information identifying the one or more mobile devices, worldwide, designated as being associated with the particular location from which the alarm was transmitted. Based on rules programmed into the system, the computers/servers 60 select at least one mobile device to which the received image data and/or audio data should be transmitted. Using the known type and model of the at least one mobile device, the computers/servers 60 reformat the received image data for display on the at least one mobile device selected, based on the particular format characteristics (e.g., screen size, frames per second, and how the video and/or audio should be delivered to the device/cell phone/handset) of the at least one mobile device. Step 160. If desired, the monitoring center can also store the received information in memory devices associated with the computers/servers 60, and particularly, will store all image data and/or other multimedia content received at or near the time of the alarm. This stored data can be indexed/catalogued for later viewing (i.e., short or long term) by the user, over the user's mobile device at a later time. Additionally or alternately, the image data and/or audio data can be stored in a format that can be made available to the user, and/or to others, over the Internet for viewing at a later time, or even multiple later times.

The image data and/or audio data, reformatted to be usefully displayed and/or heard on the particular designated at least one device, in accordance with rules defined for the model and type of device of the at least one device is transmitted to the at least one device, via the mobile network 70. Step 170. Typically, this would be a GSM Data Network, a GPRS Network, a Code Division Multiple Access (CDMA) Network, or any other network permitting connection with a mobile device. Note that, in accordance with the present embodiments, it is intended that such retransmission can occur automatically, or it can be initiated by a user. For example, instead of sending the actual multimedia file initially, the computer can transmit a text message to the user's device informing the user of the alarm and of the availability of the reformatted multimedia data file. The user can then choose to download the multimedia file to the device.

In one particular embodiment of the present invention, the image and/or audio data could be delivered from the camera 21 to the mobile device 80, in the required format, within a very short period of time. For example, in one particular embodiment of the invention, the image file would be delivered from the camera to the mobile device within forty-five seconds to a few minutes of the image data being captured.

After receiving and viewing/hearing the image and/or audio data on the mobile device, the user is able to make an informed decision, based on the content of the image file, as to what action to take (e.g., was the alarm caused by a pet, or was there a real, unauthorized intrusion event). For example, upon viewing an image file on the mobile device, the user could notify the police to come to the protected premises. Alternately, upon viewing an image file, the user could decide that the alarm was caused by a friendly party, in which case, no action would be taken by the user. As such, the user is making the final intrusion determination, based on the user's own subjective knowledge and parameters. Additionally, the system can be utilized to provide the user with information regarding a “desired” alarm event (i.e., a child coming home from school and entering the home). In this case, the alarm is beneficial, and not intended to trigger the dispatch of law enforcement to the location. The system of the present invention provides multimedia information associated with an alarm condition to a user's mobile device, in a format that is optimized for that particular mobile device. This permits the user (i.e., the most knowledgeable party about visitors to the property) to be the ultimate decision maker, and takes the final alarm determination decision away from an automated system or an employee of the service provider who may be monitoring the alarm and image data.

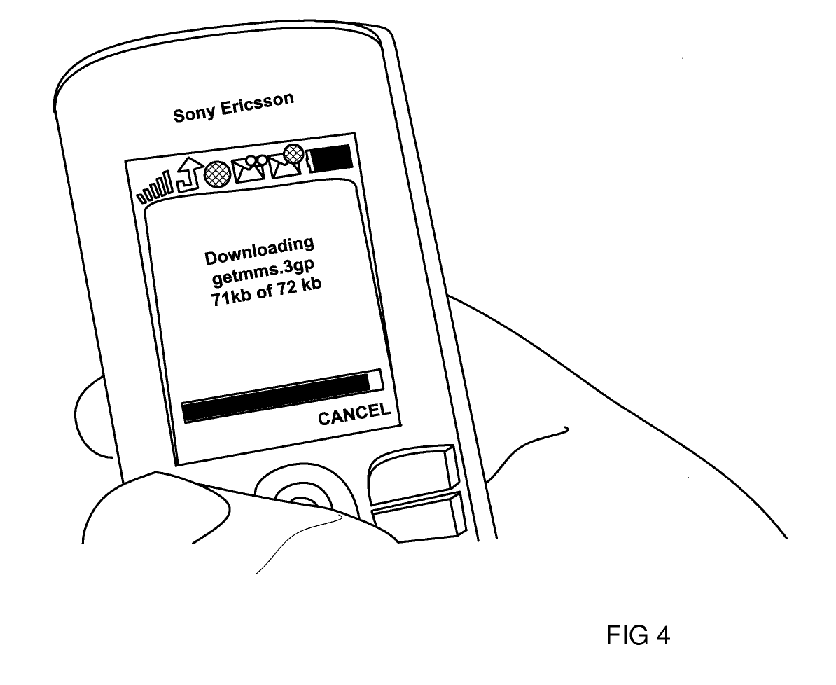

In one particular embodiment of the present invention, the mobile device receives the video by a WAP push method. WAP push enables rich content to be delivered to a device by specifying the URL (binary SMS) of a precompiled MMS host on a content provider's web server. Referring now to FIG. 4, there is shown a partial perspective view of a mobile device downloading the reformatted image data, in accordance with one particular embodiment of the present invention. More particularly, FIG. 4 demonstrates the downloading of a video clip, from the computers/servers associated with a monitoring station. Note that, if desired, captured audio information can accompany the video clip. Additionally, if further desired, image data can be omitted and audio data, only, could be provided to the user for downloading. However, in the present embodiments, it is most preferred that image data (alone, or accompanied by audio) be provided to the user.

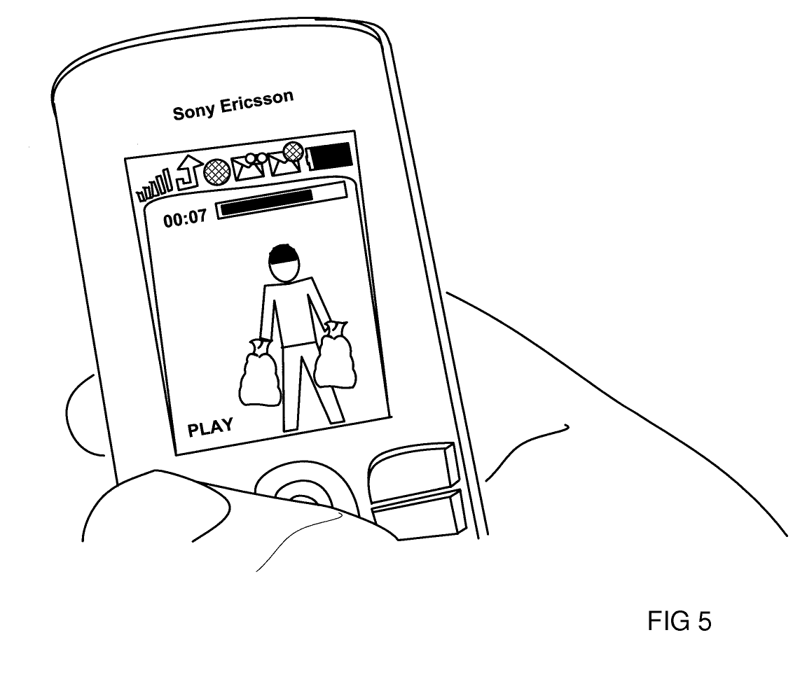

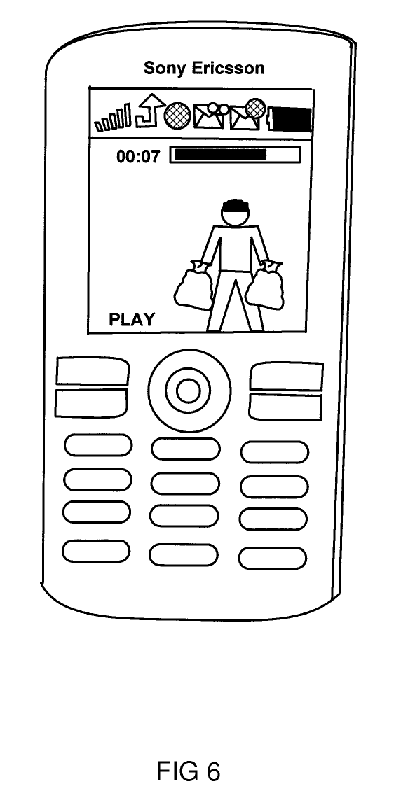

FIGS. 5 and 6 show a captured image frame from the video clip downloaded in FIG. 4. As can be seen in FIGS. 5 and 6, message (“Play”) on the display of the mobile device, in a position corresponding to a physical button on the particular device, indicates to the user how the video to be started and stopped, thus permitting a still image to be frozen on the screen of the mobile device. Additionally, a meter at the top of the mobile device screen indicates to the user the amount of video that has been displayed, and the amount of video yet to be displayed in the downloaded video clip.

In one particular embodiment shown in FIGS. 4-6, a WAP push link was sent to a particular mobile device (for example, in a text message), indicating that receipt of an alarm on a certain day, at a certain time, and additionally indicating that a video taken at the time and location of the alarm is available for viewing. The user selects the link to initiate the connection of the mobile device to the link provided, connecting the phone to the URL from the link, via the mobile network. In the illustrative example of FIG. 4, connecting to the link initiates the downloading of the getmms.3gp file containing seventy-two kilobytes. As can be seen, the mobile device of FIG. 4 is of a particular type (i.e., a cellular telephone) and of a particular make and model (i.e., a Sony Ericsson cell phone of a particular model number). In accordance with the present invention, the database maintained on behalf of the service provider is either pre-informed of this information, or detects this information view a communication with the user. As such, after receiving the image and/or audio data from the location, and prior to forwarding the image and/or audio data to the mobile network, computers/servers associated with the service provider reformat the image data file for display on the particular model of Sony Ericsson cellular telephone, in the present example, that the database says will be receiving and displaying it. Additionally, if audio information were being provided to the user's particular model of Sony Ericsson cellular telephone, that audio would have to be particularly reformatted for replay on the that device. It is important to note that, if the database indicated that the location of the alarm designated an HP IPAQ Smartphone to receive and display the image and/or audio data file(s), the computers/servers associated with the service provider would reformat the received data in a different way than would be done for the Sony Ericsson model phone of the example. As such, the same data file would be reformatted and retransmitted by the computers/servers in two different ways, in order to optimize the viewing of the image data (and/or listening of the audio data) on each device. Once the multimedia file has been downloaded by the mobile device, in accordance with the present embodiment, that file starts playing automatically.

As an alternative to sending a WAP push link, the system of the present invention can download the entire multimedia data file (i.e., and not just a link), to the mobile device. This would eliminate the step of requiring the computer to initiate the download from the service provider's computer/server by connecting, via a link. If desired, a text message informing a user of the alarm condition and of the presently accessible multimedia file can additionally be sent to the mobile device.

In summary, the present invention utilizes motion detection to capture multimedia data (i.e., image and/or audio data) and transmit it to a monitoring center, via a communications network. The multimedia data is decoded at the monitoring center and reformatted to be compatible with the user's particular mobile device, based on the particular types of requirements that the user's mobile device have, in order to receive the information in a format that the mobile device can understand and display to the user in an optimally meaningful way.

Note that the above-described embodiments are exemplary and that the above invention is not meant to be limited only to its preferred embodiments. For example, although the present embodiments are described as reformatting image data and/or audio data for a particular mobile device, it is intended that the system can be used to provide a user with any content capable of being captured and sent to a mobile device, wherein the content should be reformatted in accordance with the particular format characteristics of a particular receiving mobile device, in order to maximize the usefulness of the content. It can be seen that other modifications can be made to the preferred embodiments and still be within the spirit of the present invention.

I claim:

1. A system for providing multimedia information from a location of a detected intrusion to a particular mobile device associated with the location, the system comprising:
a motion detector;
a camera operatively connected to said motion detector, said camera being activated by said motion detector in order to capture image data once motion has been detected by said motion detector;
a communication interface for receiving the captured image data from said camera and providing it to a remote location;
a computer associated with said remote location for receiving the provided image data and determining the location of the detected intrusion, said computer determining the particular mobile device associated with the location;
said computer being programmed to reformat the provided image data for display on the particular mobile device determined, based on format characteristics particular to the particular mobile device; and
said computer further programmed to transmit the reformatted image data to the particular mobile device.

2. The system of claim 1, wherein the image data captured by the camera is a video clip.

3. The system of claim 1, wherein the image data captured by the camera is a still image.

4. The system of claim 1, further including an alarm panel at the location of the detected intrusion, said alarm panel including first communication circuitry for receiving said image data from said camera and second communication circuitry for communicating said image data received from said camera to said remote location.

5. The system of claim 1, wherein the particular mobile device is a particular model of mobile telephone.

6. The system of claim 1, wherein the particular mobile device is a particular model of PDA.

7. The system of claim 1, wherein said format characteristics particular to the particular mobile device include at least one of: screen size, frames per second, and how images should be delivered to the mobile device.

8. The system of claim 1, wherein said computer transmits said reformatted image data over a mobile network.

9. The system of claim 1, further including:
an audio capture device operatively connected to said motion detector, said audio capture device additionally being activated by said motion detector in order to capture audio information once motion has been detected by said motion detector;
said communication interface additionally receiving the captured audio information and providing it to a remote location; and
said computer being additionally programmed to reformat the captured audio information for listening on the particular mobile device determined, based on format characteristics particular to the particular mobile device and to transmit the reformatted audio information with the reformatted image data to the particular mobile device.

10. The system of claim 1, wherein said camera captures only a limited amount of image data after motion is detected.

11. The system of claim 9, wherein said audio capture device captures audio for only a limited amount of time after motion is detected.

12. The system of claim 1, wherein said computer transmits said reformatted image data in response to a request from a user.

13. The system of claim 1, wherein said computer transmits said reformatted image data automatically.

14. A method for providing multimedia information from a location of a detected intrusion to a particular mobile device associated with the location, the method comprising the steps of:
detecting motion at the location;
capturing image data in response to the detection of motion at the location;
communicating the captured image data to a remote location;
determining, at the remote location, a particular mobile device associated with the location;
reformatting the image data for display on the determined particular mobile device, based on format characteristics particular to the particular mobile device; and
transmitting the reformatted image data to the particular mobile device.

15. The method of claim 14, wherein the particular mobile device is a particular model of mobile telephone.

16. The method of claim 14, wherein the particular mobile device is a particular model of PDA.

17. The method of claim 14, wherein the transmitting step occurs over a mobile network.

18. The system of claim 14, wherein the format characteristics particular to the particular mobile device include at least one of: screen size, frames per second, and how images should be delivered to the mobile device.

19. The method of claim 14, further including the steps of:
capturing audio information in response to the detection of motion at the location;
communicating the captured audio information to a remote location;
reformatting the captured audio information for replay on the determined particular mobile device; and
transmitting the reformatted audio information with the reformatted image data.

20. The method of claim 19, wherein audio is captured for only a limited amount of time after motion is detected.

21. The method of claim 14, further wherein the reformatted image data is transmitted in the transmitting step in response to a request from a user.

22. The method of claim 14, wherein the reformatted image data is automatically transmitted in the transmitting step.

23. A system for providing multimedia information from a location of a detected intrusion to a particular mobile device associated with the location, the system comprising:
a motion detector;
an audio capture device operatively connected to said motion detector, said audio capture device being activated by said motion detector in order to capture audio data once motion has been detected by said motion detector;
a communication interface for receiving the captured audio data from said camera and providing it to a remote location;
a computer associated with said remote location for receiving the provided audio data and determining the location of the detected intrusion, said computer determining the particular mobile device associated with the location;
said computer being programmed to reformat the provided audio data for replay on the particular mobile device determined, based on format characteristics particular to the particular mobile device; and
said computer further being programmed to transmit the reformatted audio data to the particular mobile device.
